(19) United States
(12) Patent Application Publication
(10) Pub. No.: US 2015/0193444 A1
(43) Pub. Date: Jul. 9, 2015

(54) System and method to determine social relevance of Internet content

(71) Applicants: Daniel Gardiner, Whitby (CA); Kevin Gardiner, Ajax (CA)

(72) Inventors: Daniel Gardiner, Whitby (CA); Kevin Gardiner, Ajax (CA)

(21) Appl. No.: 14/588,976

(22) Filed: Jan. 4, 2015

Related U.S. Application Data
(60) Provisional application No. 61/923,640, filed on Jan. 4, 2014.

(51) Int. Cl. G06F 17/30

(52) U.S. Cl. CPC G06F 17/3053

(57) ABSTRACT

Embodiments of the present invention provide systems and methods for determining social relevance of internet content. The method according to one embodiment comprises selecting an item from the result set, measuring the amount of social participation of said item from social networks and conducting sentiment analysis of said items content which may be used for further ranking of items within the result set.

### CROSS-REFERENCE TO RELATED APPLICATIONS

This application is a continuation of U.S. patent application Ser. No. 61/923,640, filed Jan. 4, 2014

### BACKGROUND OF THE INVENTION

Most search engines search in a concise representation of the contents of one or more content items called an “index”.

In order to create an index, a given content item, such as an HTML document, is first broken into a list of words, a process known as tokenization. After tokenization, words may be normalized to a standard form. For example, suffixes and plural endings may be removed by a process known as “stemming” or “morphological analysis”. In addition, very common words known as “stop words” may be omitted. Finally, each occurrence of each word is recorded in the index. The entire process of transforming the content item from its original form into a set of entries in an index is known as “indexing.”

An index is a data structure consisting of a table of lists. Each entry in the table is accessed by a unique word, and each item in the list for a given word indicates a content item in which that word occurred. These items are called “postings,” and the lists are called “posting lists.” A posting contains an identifier for the content item containing the word, and may also include additional information about how often or where the word appeared in the content item.

When a user provides a query to a search engine that employs an index, the system breaks the query into words in much the same way that the system processes content items. The system then looks in the table to find the posting list for each word. Each posting list represents the set of content items containing the word. If the user's query is interpreted as a Boolean OR then the union of the sets is computed. If the user's query is interpreted as a Boolean AND then the intersection of the sets for each word is computed. In most search engines, a relevance score is computed for each candidate content item in the result set, and only the top-scoring candidates are retrieved. An assortment of factors may determine the relevance score, including the frequency of occurrence of the query words, the properties of the content items modification date and statistical distinctiveness.

The World Wide Web consists of billions of content items, known as web pages, interconnected by hypertext links which allow users to navigate from a “source” page (the page containing the link) to a “target” page (the page pointed to by the link). Each page on the Web has a unique address known as a Uniform Resource Locator (“URL”). Hypertext links on the web contain two pieces of information: a short piece of text, known as a summary or anchor text that describes the target page and the URL of the target page.

Due to the unique nature of the interlinked pages and the large scale of the Web, search engines typically employ more complex relevance ranking functions. In addition to the ranking features used in traditional search engines, web search engines also rely on information based on the connectivity of the page, such as the number of pages linking to it, in determining the relevance score of a search result.

Unfortunately, existing indexes used by search engines may not capture the precise diction that a user query comprises along with context provided through social participation information, sentiment analysis of each content item and sentiment analysis of social network comments for each content item in a result set raising issues with the quality of content items. As a result users are increasingly presented with disinformation when attempting to locate content items on the Internet. Due to the exploitation of shortcomings in existing search algorithms, users are confronted with issues of trust regarding content items in a result set that they locate on the Internet, including the content contained within such content items.

Therefore, new sources of information on which to base searches, as well as methods of using the same, are needed. Furthermore, new sources of information on which to base the ranking of content items in a result set are needed, as well as techniques of using the same, which may be used alone or in conjunction with existing searching and ranking techniques known in the art. Additional sources of information provide new ways to index and rank content items and the content contained therein, leading to more reliable search results for users.

### BRIEF SUMMARY OF THE INVENTION

The present invention provides systems and methods for improving searches over a corpus of content items, including improving the ranking of result sets produced by such searches to provide users with social relevant results.

Embodiments of the present invention generate a social network profile that comprises information describing details of user interactions with one or more content items. According to one embodiment of the present invention, information of user interactions includes, but is not limited to, interactions such as sharing, liking, voting, commenting, tagging and other user interaction with one or more content items.

Information details of user interactions on social networks may be treated in a manner similar to other information comprising a content item for indexing, searching and ranking purposes. For example, publically accessed comments from social networks may be treated similar to anchor text from a web page. Information detailing user interactions, like anchor text includes descriptive text, but is created by individuals other than the author of a content item. In addition this information provides descriptions, opinions, view counts, social participation counts that might not be found in the original content item.

Information detailing of user interactions on various social networks may be used to improve indexing, searching and ranking of content items. One exemplary mechanism would be as follows: When a user saves a content item for the first time, the text of the content item (metadata included) is added to a search engine's index. Any relevant social network user interaction information details can also be stored, saved or indexed, whereby this information is treated as separate fields of content from the content item and when additional users save the content item at a later point, the content item is not re-indexed, but relevant social network user interaction details from the additional users is stored, saved or indexed. When queries are executed over both the contents of the saved content item as well as the information detailing user interaction from various social networks, thereby providing several benefits. First, search systems and methods of the present invention utilize the comments from the user interaction information from various social networks which is capable of adding additional visual ranking queues to the user providing a summarized automated sentiment analysis of the data. Second the search systems and method of the present invention may harness the amount of social participation from the information on user interactions from various social networks to improve the relevance scoring and ranking of content items, providing more socially relevant results to users. This information may also be aggregated and indexed according to communities or social networks of users.

According to embodiments of the invention, sentiment analysis through natural language processing of the content items may be stored, saved or indexed, whereby this information is treated as separate fields of content from the content item. The search systems and methods of the present invention utilize the sentiment analysis of the content items for additional relevancy ranking and presenting summarized sentiment information to the user to provide visual context for quality to search results.

### BRIEF DESCRIPTION OF THE DRAWINGS

FIG. 1. is a schematic diagram of an example system and method for computing social relevancy of internet content.

FIG. 2. is a screen diagram illustrating the graphical interface to deliver socially relevant web search result set for interaction with the user.

FIG. 3. is a screen diagram illustrating the graphical user interface to deliver socially relevant image search result set for interaction with the user.

FIG. 4. is a screen diagram illustrating the graphical user interface to deliver socially relevant video search result set for interaction with the user.

FIG. 5. is a screen diagram illustrating the graphical user interface to deliver socially relevant news article search result set for interaction with the user.

### DETAILED DESCRIPTION AND BEST MODE OF IMPLEMENTATION

The present invention generally relates to the systems and methods for improving the reliability of items in a result set resulting from execution of a search over a corpus of content items, as well as the order in which the items are presented to a user. The following description of exemplary embodiments of the invention may be generally implemented in software and hardware computer systems, using combinations of both server-side and client-side hardware and software components, to provide a system and method for improving the relevancy of a result set returned by a search engine. The system may be embodied in a variety of different types of hardware and software as is readily understood by those of skill in the art and are not intended to limit the scope of the invention to these exemplary embodiments, but rather to enable any person skilled in the art to make and use the invention. The system may, for example, provide an application program interface (“API”) for use by engineers to collect information to assist in the indexing of content items, as well as provide techniques for using the information for searching and ranking of result sets based on user queries.

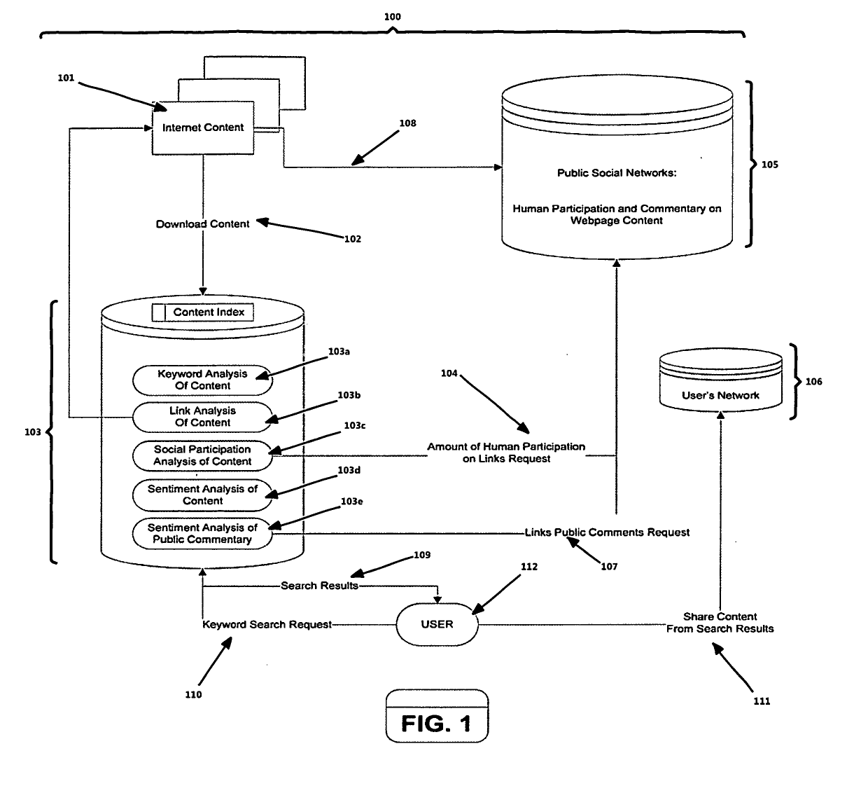

FIG. 1 illustrates a system 100 that provides method to determine social relevancy of internet content in accordance with this invention. Due to the vast number of content items located on the Internet, it is increasingly difficult to locate content items on interest. A search provider 103 provides a mechanism that allows clients to search for content items of interest. A search provider 103 according to the present invention comprises an download component 102, an index data store 103f, a keyword analysis of content 103a, a link analysis of content 103b, social participation analysis of content 103c, sentiment analysis of content 103d and sentiment analysis of public comments of content 103e. It should be noted that the search provider 103 and its constituent components and data stores may be deployed across a network in a distributed manner whereby key components are duplicated and strategically placed throughout a network for increased performance and scalability.

In addition to using the download component 102 to collect internet content items 101 from over the network and index 103f them, the search provider 103 may also collect information on social participation 103c by using the Uniform Resource Locator (“URL”) of said indexed content for measuring the amount of user interactions 104 from several different social networks 105 about the content to be used for determining level of importance by human interaction and rank. Examples include number of shares, posts, comments and votes.

In addition the search provider 103 may also conduct analysis of downloaded 102 and indexed 103f content from the internet 101. The analysis consisting of a keyword analysis of content 103a to be tokenized so it can be searched via keyword search requests 110 from the user.

A link analysis may be conducted via the search provider 103 on the indexed 103f content by examining and measuring the amount of nodes and hyperlinks to and from the content to indicate a level of importance and rank of the particular content with regards to the webgraph (“describing the directed links between content of the World Wide Web”).

The search provider 103 may also conduct sentiment analysis 103d on the indexed 103f content according to propagation techniques known to those of skill in the art by natural language processing, computational linguistics, and text analytics to identify and extract subjective information and opinion mining from the indexed content 103f to provide as additional relevancy ranking and contextual information presented to the user in the search results 109.

In addition the search provider 103 may also conduct sentiment analysis 103e of public commentary from the various social networks about the indexed content 103f by using the Uniform Resource Locator (“URL”) of said indexed content to identify public comments about the content which can be analyzed by natural language processing, computational linguistics, and text analytics to identify and extract subjective information and opinion mining which can then be provided as additional ranking information and presented to the user in the search results 109.

The search provider will present search results 109 to the user 112 based on the users keyword search request 110. The results set are presented to the user first, preferably according to descending relevance, e.g., the first content item in the result set is the most relevant to the query and the last content item in the result set is the least relevant to, yet still falling within the scope of, the query based on ranking the items using the above mentioned analysis methods for content, link analysis 103b, keyword analysis 103a, social participation analysis 103c, sentiment analysis of content 103d and public commentaries 103e. The search results returned to the user can then share individual items 111 from the search results 109 to their respective user network 106, examples include user's own social network, individual email contacts and social bookmarks.

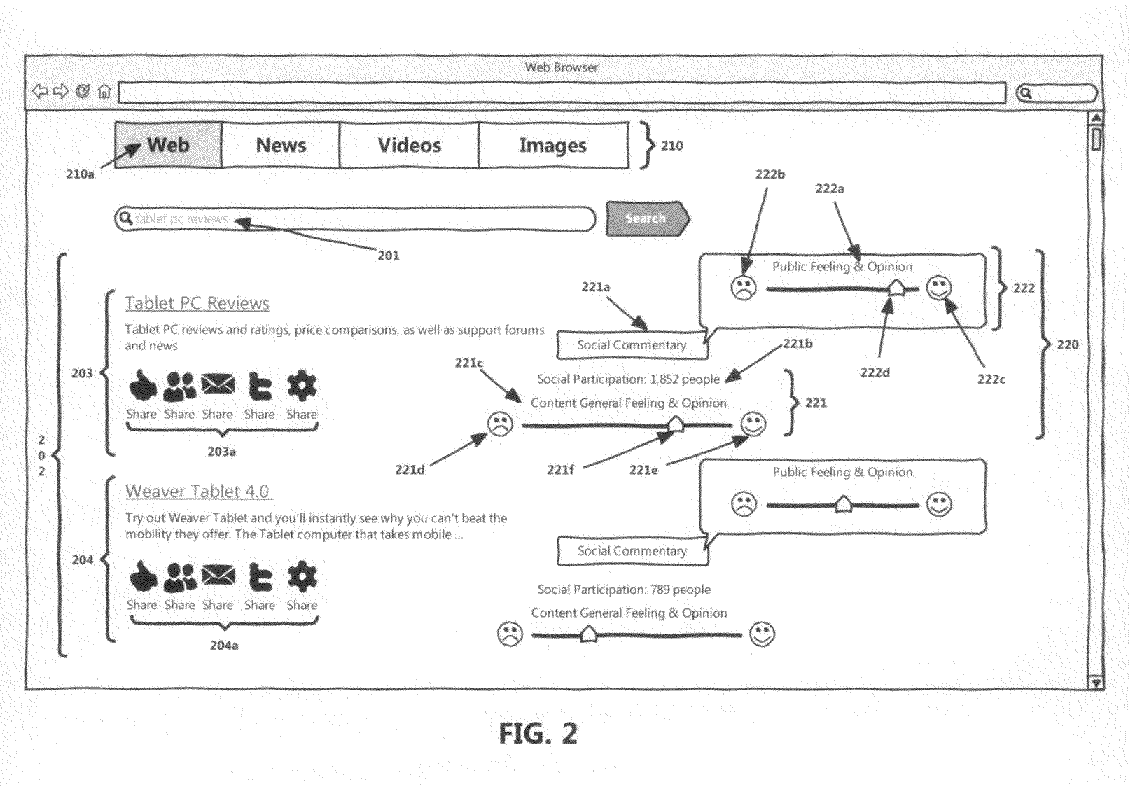

FIG. 2 illustrates a graphical interface to deliver social relevant web content search result sets 210a to a user based on their input keyword search request 201. The user may switch between different search filters to display different result sets based on example content types such as Web, News, Videos and Images 210. The result set 202 contains a set of social relevant items returned to the client 203 204 from the search provider 103 referred in FIG. 1. Each item within the result set contains detailed information 220 with regards to the content, displaying the summarized sentiment analysis of said content 221, expressed as a general feeling and opinion scale 221c based from negative 221d to positive 221e highlighting the position 221f the content is within the scale regarding it's sentiment score derived from the sentiment analysis 103d done by the search provider 103 referred in FIG. 1.

In addition the social participation measurement 103c returned from the search provider 103 referred in FIG. 1 may be displayed to the user from the graphical interface for each item of the content results set 221b. Social commentary 221a may be provided to the user in the results set for each content item based on the sentiment analysis 103e done by the search provider 103 referred in FIG. 1. A summarized scale 222 may be presented to the user indicating the overall sentiment score 222d of the public opinion of each content item 222a based on the negative 222b to positive 222c scale.

In addition the user may share each content item from the search results set 203a 204a to the users respective networks, examples are the user's social network, email contacts, blogs.

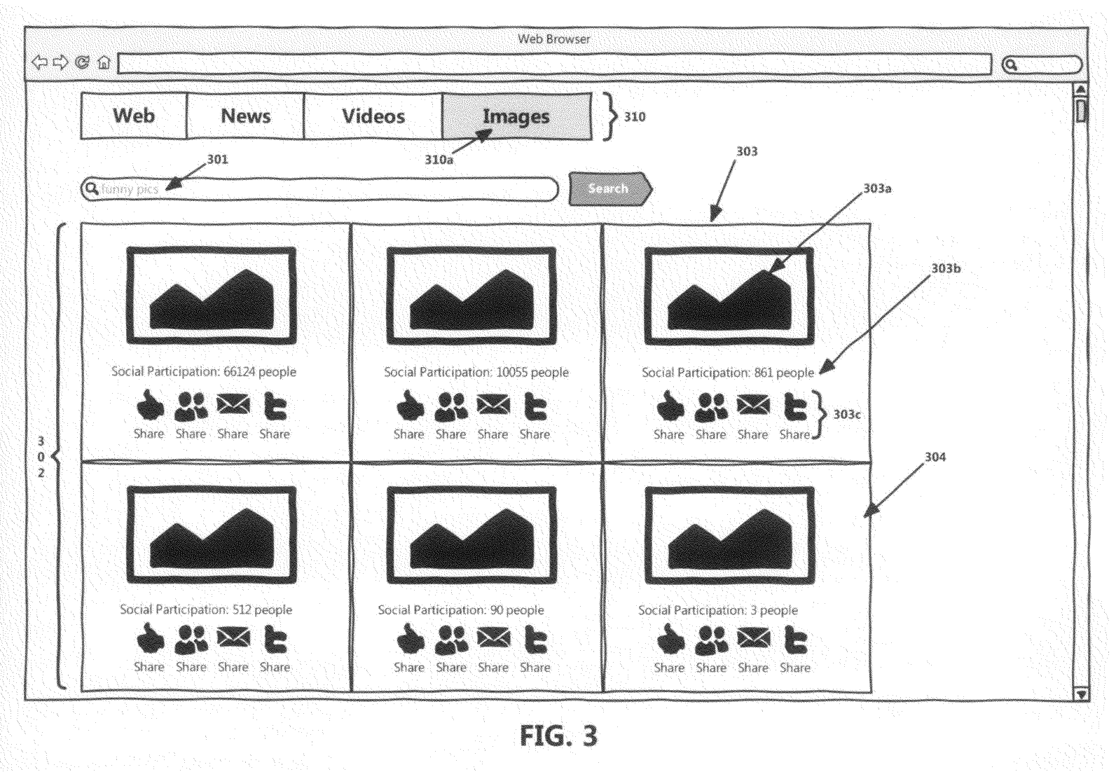

FIG. 3 illustrates a graphical interface to deliver social relevant image content filtered search result sets 310a to a user based on their input keyword search request 301. The user may switch between different search filters to display different result sets based on example content types such as Web, News, Videos and Images 310. The result set 302 contains a set of social relevant image items returned to the client 303 304 from the search provider 103 referred in FIG. 1. Each image item within the result set contains the content image 303a, detailed information 303b with regards to the social participation the image has received from social networks.

In addition the user may share each content item from the image content search results set 303c to the users respective networks, examples are the user's social network, email contacts, blogs.

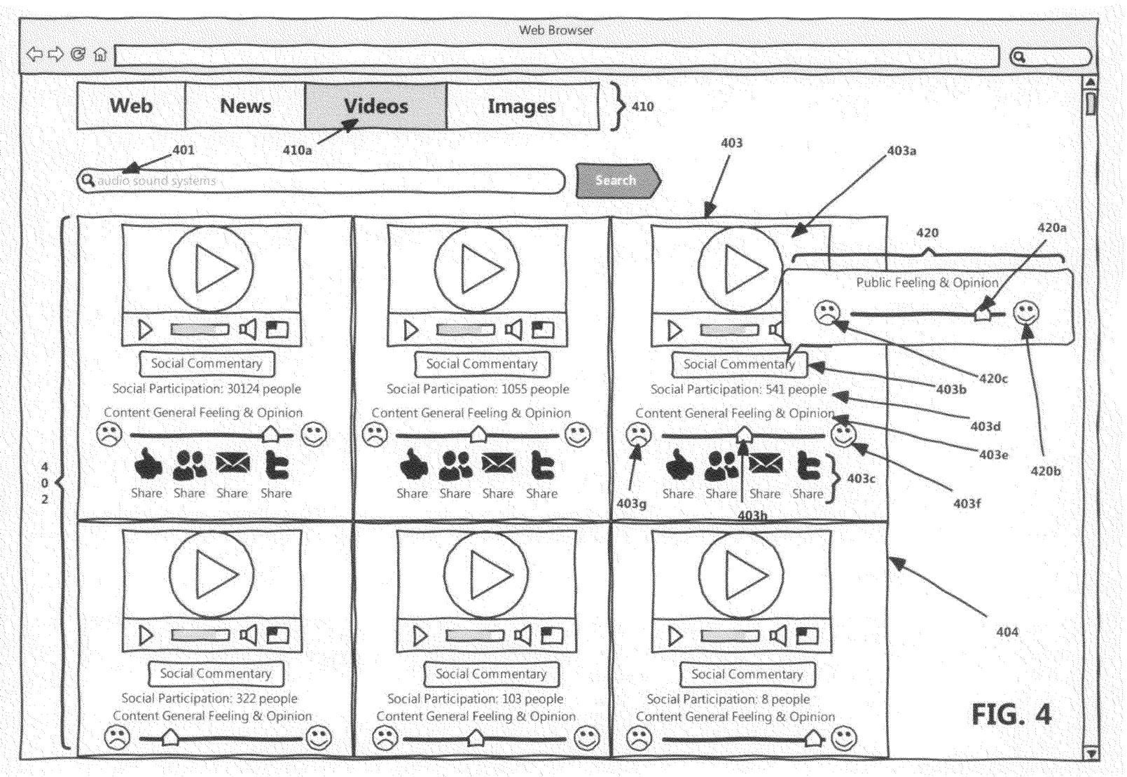

FIG. 4 illustrates a graphical interface to deliver social relevant video content filtered search result sets 410a to a user based on their input keyword search request 401. The user may switch between different search filters to display different result sets based on example content types such as Web, News, Videos and Images 410. The result set 402 contains a set of social relevant video items returned to the client 403 404 from the search provider 103 referred in FIG. 1. Each video item within the result set contains the content video 403a, detailed information with regards to the content, displaying the summarized sentiment analysis of said content 403e, expressed as a general feeling and opinion scale based from negative 403g to positive 403f highlighting the position 403h the content is within the scale regarding it's sentiment score derived from the sentiment analysis 103d done by the search provider 103 referred in FIG. 1.

In addition the social participation measurement 403d returned from the search provider 103 referred in FIG. 1 may be displayed to the user from the graphical interface for each item of the content results set 403d. Social commentary 403b may be provided to the user in the results set for each content item based on the sentiment analysis 103e done by the search provider 103 referred in FIG. 1. A summarized scale 420 may be presented to the user indicating the overall sentiment score 420a of the public opinion of each content item 420 based on the negative 420c to positive 420b scale.

In addition the user may share each content item 403 404 from the video search results set to the users respective networks 403c, examples are the user's social network, email contacts, blogs.

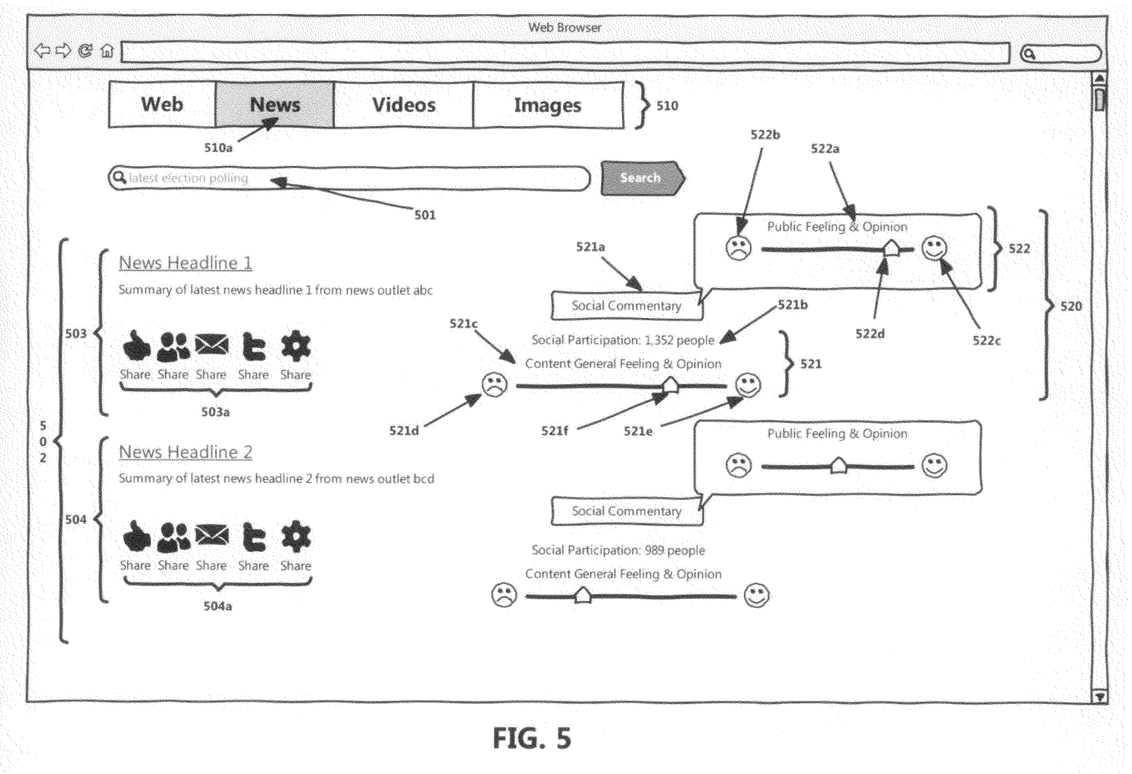

FIG. 5 illustrates a graphical interface to deliver social relevant news content filtered search result sets 510a to a user based on their input keyword search request 501. The user may switch between different search filters to display different result sets based on example content types such as Web, News, Videos and Images 510. The result set 502 contains a set of social relevant items returned to the client 503 504 from the search provider 103 referred in FIG. 1. Each item within the result set contains detailed information 520 with regards to the content, displaying the summarized sentiment analysis of said content 521, expressed as a general feeling and opinion scale 521c based from negative 521d to positive 521e highlighting the position 521f the content is within the scale regarding it's sentiment score derived from the sentiment analysis 103d done by the search provider 103 referred in FIG. 1.

In addition the social participation measurement 103c returned from the search provider 103 referred in FIG. 1 may be displayed to the user from the graphical interface for each item of the content results set 521b. Social commentary 521a may be provided to the user in the results set for each content item based on the sentiment analysis 103e done by the search provider 103 referred in FIG. 1. A summarized scale 522 may be presented to the user indicating the overall sentiment score 522d of the public opinion of each content item 522a based on the negative 522b to positive 522c scale.

In addition the user may share each content item from the search results set 503a 504a to the users respective networks, examples are the user's social network, email contacts, blogs.

1. A computer-implemented method to determine social relevance of internet content comprising:
receiving a query request from a user comprising one or more search terms;
traversing an index in response to the query, the index comprising a location of each of a plurality of content items, words parsed from each of the plurality of content items, social network participation information for each of the plurality of content items, sentiment analysis data for each of the plurality of content items and sentiment analysis data of public comments from social networks regarding each of the plurality of content items;
wherein calculating a rank for each of the plurality of content items comprising of keyword analysis and link analysis;
re-ranking each of the plurality of content items based on social relevance;
wherein calculating social relevance for each of the plurality of content items further comprises a score from the amount of social participation information, the weight of sentiment analysis data of the social network comments and the weight of sentiment analysis data for the content;
sending the re-ranked plurality of content items as search results to a client device for display to a user;

2. The method of claim 1 wherein search results display summarized sentiment analysis data for the plurality of content items.

3. The method of claim 2 wherein the sentiment analysis data is expressed as general feeling and opinion information, highlighting where each of the plurality of content items score with-in a negative to positive scale derived from natural language processing.

4. The method of claim 1 wherein search results display summarized sentiment analysis data of public comments from social networks for the plurality of content items.

5. The method of claim 4 wherein the sentiment analysis data is expressed as general feeling and opinion information, highlighting where public commentary for each of the plurality of content items is with-in a negative to positive scale derived from natural language processing.

6. The method of claim 1 wherein the index is an inverted index.

7. The method of claim 1 wherein search results will display social participation information.

8. The method of claim 7 wherein the social participation information includes, but is not limited to, social network interactions such as sharing, liking, voting, commenting, tagging and other user interaction for the plurality of content items.

9. A computer system to determine social relevance of internet content comprising:
a search engine that receives a search query and obtains a list of URLs of content items as search results from an index comprising;
a plurality of content items from a plurality of different internet data sources comprising:
URLs of the content items, words parsed from each of the content items, social network participation information for each of the content items, sentiment analysis data for each of the content items and sentiment analysis data of public comments from social networks regarding each of the content items;
wherein the search engine calculates a rank for the search results comprising of keyword analysis and link analysis;
wherein the search engine re-ranks the search results using social relevance. wherein re-ranking the search results using social relevance further comprises calculating a score from the amount of social participation information, the weight of sentiment analysis data of the social network comments and the weight of sentiment analysis data of the content item;

10. The system of claim 9 further comprising a computer device operably coupled to the search engine to display the list of URLs of content items ranked using social relevance.
